(19) United States
(12) Patent Application Publication
(10) Pub. No.: US 2012/0167636 A1
(43) Pub. Date: Jul. 5, 2012

(54) LAUNDRY DRYER AND WASHER DRYER

(75) Inventors: Shigeharu Nakamoto, Hyogo (JP); Yuji Ozeki, Shiga (JP); Kouji Nakai, Kyoto (JP); Norihiko Fujiwara, Shiga (JP); Ahin Kang, Shiga (JP)

(73) Assignee: PANASONIC CORPORATION, Kadoma-shi, Osaka (JP)

(21) Appl. No.: 13/392,818

(22) PCT Filed: Oct. 8, 2010
(86) PCT No.: PCT/JP2010/006034

§ 371 Date: Mar. 22, 2012

(30) Foreign Application Priority Data
Oct. 16, 2009 (JP) 2009-238911

(51) Int. Cl. D06F 35/00; F26B 11/02

(52) U.S. Cl. 68/19; 34/108

(57) ABSTRACT

Provided is a laundry dryer including a first duct having a first outlet opening at the rear of a drum storing laundry, and a second duct with a second outlet opening at the front of the drum. The second outlet has a smaller bore allowing air passage than the first outlet. The first and second ducts are selectively switched during the drying process in response to temperature detectors which detect the dry air temperature before and after contact between the air and the laundry. A larger volume of air is blown from the first outlet under selection of the first duct than the second duct whereas the dry air is blown from the second outlet at higher pressure and higher velocity under selection of the second duct than the first duct.

### BACKGROUND OF THE INVENTION

1. Field of the Invention

The present invention relates to a laundry dryer which dries laundry and a washer dryer which has washing and drying functions for the laundry.

2. Description of the Related Art

A conventional drum-type laundry dryer or washer dryer blows dry air into a drum through a duct, so that the dry air comes into contact with the laundry, which is placed in the drum, and gets rid of moisture from the laundry to be dried. The dry air, which contains the moisture and becomes humid, is exhausted to the duct outside the drum. Since the laundry is typically dried within a limited and confined drum space, there are problems about strongly wrinkled laundry after the drying process. Various resolutions have been devised against the problems (c.f., Patent Document 1).

FIG. 11 shows a conventional drum-type washer dryer described in Patent Document 1. As shown in FIG. 11, the conventional drum-type washer dryer blows dry air from a first duct 121 and a second duct 122 into a rotary drum 123 to increase an air volume during the drying process and facilitate to evaporate moisture from the laundry 124, which results in shortened drying time. The air is blown at high velocity toward the laundry 124 placed inside the rotary drum 123 from a second outlet 125 of the second duct 122, which is situated at a lower portion of the rotary drum. The dry air is blown so as to move up and agitate the laundry 124. Therefore, it becomes less likely that the laundry 124 wrinkles, which, in turn, leads to improved end results of the drying process.

According to the conventional configuration, the air is blown to the laundry 124 at high pressure and high velocity. In general, if the air volume is the same level, a higher pressure and a higher velocity at which the air is blown, however, means an increase in load. Therefore, the motor used for a fan to blow the air consumes a lot of power. The conventional configuration uses two motors for the fans to increase the air volume blown into the rotary drum 123, which results in increased power consumption as well. Accordingly, the conventional drum-type washer dryer faces difficulties in stretching wrinkles in a short drying time with low power consumption. Patent Document 1: JP 2009-72502 A

### SUMMARY OF THE INVENTION

An object of this invention is to provide a laundry dryer and a washer dryer, which consume low power to dry laundry with causing few wrinkles.

The laundry dryer according to one aspect of the present invention has: a storage portion which stores laundry to be dried; a first duct including a first outlet which opens toward the storage portion; a second duct including a second outlet which has a narrower cross-section allowing air to pass than the first outlet; a duct switcher which selectively switches between the first and second ducts; a blower which blows dry air so that a larger volume of the dry air is blown from the first outlet into the storage portion under selection of the first duct than the second duct and so that the dry air is blown from the second outlet into the storage portion at higher pressure and higher velocity under selection of the second duct than the first duct; an exhaust temperature detector which detects a temperature of the dry air exhausted from the storage portion after the dry air comes into contact with the laundry; and a controller which controls the duct switcher in response to a detection result of the exhaust temperature detector to selectively switch between the first and second ducts during a drying process.

The laundry dryer and washer dryer according to the present invention may consume less power to dry laundry with causing few wrinkles due to less power consumption at the blower.

The other objects, features and unique aspects of the present invention should be sufficiently understandable from the ensuing descriptions. The advantages of the present invention should be obvious from the ensuing explanation which is given with reference to the appended drawings.

### BRIEF DESCRIPTION OF THE DRAWINGS

FIG. 1 is a lateral cross-sectional view schematically showing a configuration of the drum-type washer dryer according to one embodiment of the present invention.

FIG. 2 is a lateral cross-sectional view schematically showing a configuration of the drum-type washer dryer according to one embodiment of the present invention.

FIG. 3 is a block diagram showing a schematic configuration of the drum-type washer dryer.

FIG. 4 is a time chart exemplifying first switching timings of the duct in the drum-type washer dryer.

FIG. 5 is a time chart exemplifying second switching timing of duct in the drum-type washer dryer.

FIG. 6 is a time chart exemplifying third switching timing of duct in the drum-type washer dryer.

FIG. 7 is a time chart exemplifying fourth switching timing of duct in the drum-type washer dryer.

FIG. 8 is another time chart exemplifying fourth switching timing of the duct in the drum-type washer dryer.

FIG. 9 is an explanatory diagram showing changes in dryness factor and the dry air temperature during the drying process if there is a constant-rate drying period.

FIG. 10 is an explanatory diagram showing the changes in the dryness factor and the dry air temperature during the drying process mostly without a drying period at constant-rate.

FIG. 11 is a lateral cross sectional view schematically showing a configuration of a conventional drum-type washer dryer.

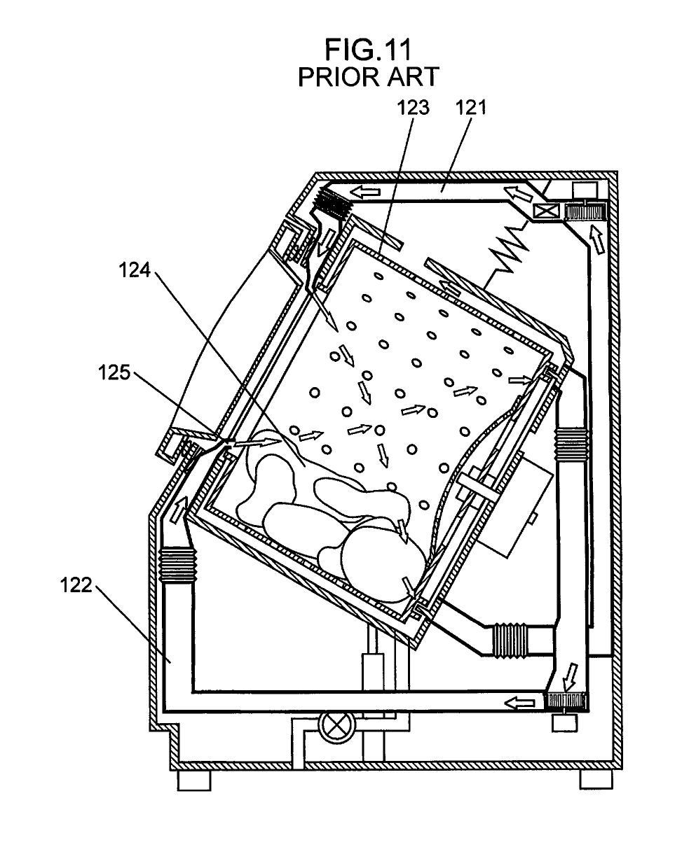

### DETAILED DESCRIPTION OF THE PREFERRED EMBODIMENTS

The exemplary drum-type washer dryer of the present invention is described with reference to the accompanying drawings. It should be noted that the following embodiments are examples for embodying the present invention, and are not intended for limiting any technical scopes of the present invention.

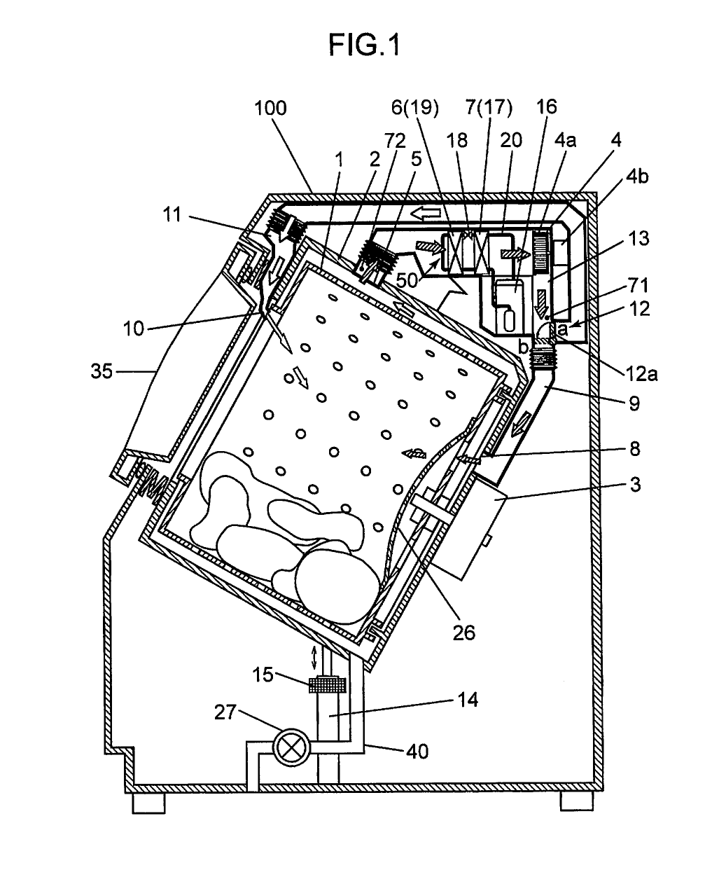

FIG. 1 is a lateral cross sectional view of the drum-type washer dryer according to one embodiment of the present invention.

In FIG. 1, a cylindrical drum 1 (storage portion), which opens forward and has a bottom surface to store laundry, is supported inside the housing 100. The cylindrical drum 1 is stored in a cylindrical water tub 2 which stores wash water. A drum drive motor 3 (drum driver) is mounted on the rear surface of the water tub 2. The drum drive motor 3 rotates the drum 1 around the rotating axis which is inclined upward to the front.

The housing 100 is provided with a door 35 which faces the open-end side of the drum 1, so that a user may open the door 35 to place and take out laundry (clothes) in and from the drum 1. A water supply pipe, on which a water supply valve (not shown) is mounted, and a drain pipe 40, on which a drain valve 27 is mounted, are connected to the water tub 2.

A blower 4 blows dry air to dry the laundry, so that the dry air getting rid of moisture from the laundry in the drum 1 becomes humid. The dry air then passes through an exhaust outlet 5 situated on the circumferential surface of the drum 1 and is exhausted outside the drum 1. The exhausted dry air is dehumidified by a dehumidifier 6. The dehumidified dry air by the dehumidifier 6 is then heated by a heater 7. The heated dry air is guided by one of a first duct 9 or a second duct 11, and is once again blown into the drum 1. The first duct 9 includes a first outlet 8 which opens at the rear of the drum 1 whereas the second duct 11 includes a second outlet 10 which opens at the front periphery of the drum 1. The first outlet 8 of the first duct 9 has a larger cross-sectional area, through which the air passes, than the second outlet 10. A large volume of the dry air may be blown from the first outlet 8 in comparison to the second duct 11 due to less pressure loss of the first outlet 8. The second outlet 10 of the second duct 11 has a narrower cross-sectional area, through which the air passes, than the first outlet 8. The dry air is blown at higher pressure and higher velocity into the drum 1 in comparison to the first outlet 8.

In the case of drum-type washer dryers, it is usual to narrow a gap between the front of the rotary drum 1 and the water tub 2 as much as possible, in order to prevent the laundry from entering into the gap. The second outlet 10 may be placed in this narrow space because the second outlet 10 has the relatively narrow cross-sectional area, through which the air is blown at high pressure and high velocity, although it is spatially difficult to mount an exhaust outlet which has a wide opening to cause little pressure loss. On the other hand, there is a space wide enough at the rear end of the drum 1 to place the first outlet 8, which has a relatively large opening, on the bottom surface. If the first outlet 8 is covered with a cover 26 on which numerous perforations are formed at a large aperture ratio to allow air passage, it becomes less likely that the laundry enters in the first outlet 8. Accordingly, the first outlet 8, which has relatively small pressure loss, may be mounted on the bottom surface of the drum 1 at the rear.

If the laundry is agitated by the rotation of the drum 1 around the rotation axis which is inclined upward to the front, it becomes likely that small laundry such as socks, handkerchiefs and briefs gathers at the rear end of the drum 1. Meanwhile, it becomes likely that long laundry such as long-sleeved underwear, long pants, long-sleeved dress shirts and long-sleeved pajamas gathers at the front of the drum 1. Accordingly, if a mixture of small and long laundries is dried and if a large volume of the dry air is blown from the first outlet 8, which is situated at the rear end of the drum 1, the dry air comes into contact with the small laundry at first because the small laundry gathers at the back of the drum 1. The dry air then passes through the small laundry to reach the long laundry at the front of the drum 1. Thus, both the small and long laundries may be efficiently dried. In particular, the small laundry may be dried with relatively few wrinkles It is likely that the long laundry wrinkles because sleeves and alike are likely to be twisted by the agitation during the drying process. If wind (dry air) is blown from the second outlet 10 at the front of the drum 1 and comes in contact with the long laundry, the drying speed may go up because the long laundry tends to gather at the front of the drum 1. If the wind (dry air) is blown from the second outlet 10 at high pressure and high velocity and comes into contact with the long laundry, it becomes likely that the long laundry is stretched. In addition, the long laundry is moved a lot by the wind, so that the wrinkles are also effectively decreased.

A duct switcher 12 is situated at the bifurcation of the first and second ducts 9, 11 which are situated at the downstream side of the blower 4. The duct switcher 12 is used to switch the passage of the dry air to one of the first and second ducts 9, 11. The duct switcher 12 comprises a valve 12a, which is pivotally supported at the bifurcation of the first and second ducts 9, 11, and a driver (not shown) which drives and rotates the valve 12a. If the valve 12a rotates to “a-side” in FIG. 1 to close the second duct 11, the first duct 9 opens, so that the dry air blown by the blower 4 may pass through the first duct 9. On the other hand, if the valve 12a rotates to “b-side” in FIG. 1 to close the first duct 9, the second duct 11 opens so that the dry air blown by the blower 4 may pass through the second duct 11.

The blower 4 and the duct switcher 12 are situated in a circulation duct 13. The dry air goes through the drum 1, the exhaust outlet 5, the dehumidifier 6 and the heater 7 sequentially and is blown out again from the first or second outlet 8, 10. Thus, the dry air is circulated in the drum-type washer dryer.

The blower 4 is situated between the heater 7 and the duct switcher 12. The dry air heated by the heater 7 is blown by the blower 4 toward the downstream side of the circulation duct 13. The blower 4 comprises a blast fan 4a and a blast fan motor 4b. The blower 4 rotates the blast fan 4a so that volumetric air flow through the first duct 9 becomes a predetermined air volume which is greater than the air volume through the second duct 11 if the duct switcher 12 switches to the first duct 9. If the duct switcher 12 switches to the second duct 11, the blast fan 4a is rotated so that the air passing through the second outlet 10 of the second duct 11 becomes a predetermined air velocity which is higher than the velocity of the air passing through the first outlet 8. For example, the velocity of the air passes through the first outlet 8 may be set to about 10 m/s while the velocity of the air passing through the second outlet 10 may be set to no less than 50 m/s. It should be noted that the velocities of the air passing through the first and second outlets 8, 10 are not limited to the aforementioned values. The air velocity may be set to any value as long as the air velocity through the second outlet is higher than the air velocity through the first outlet 8.

The drum-type washer dryer according to this embodiment operates the duct switcher 12 to switch between the first and second ducts 9, 11 during the drying process, so that a larger volume of the air passes through the first duct 9 than the second duct 11, and the air passes at higher velocity through the second outlet 10 of the second duct 11 than the first outlet 8.

The exhaust outlet 5 is relatively farther from the first outlet 8 than the second outlet 10 (i.e., the exhaust outlet 5 is relatively closer to the second outlet 10 and farther from the first outlet 8). Thus, the exhaust outlet 5 is closer to the front than the rear of the drum 1. The exhaust outlet 5 may be closer to the second outlet 10 at the front of the drum 1 so that the exhaust outlet 5 becomes the most distant from the first outlet 8.

The exhaust outlet 5 is situated in an upper portion of the drum 1, so that the dry air may be effectively exhausted upwardly after the contact with the laundry. It should be noted that the exhaust outlet 5 may be situated at another place than at the upper portion of the drum 1 in a drum-type laundry dryer, which excludes washing functions. The exhaust outlet 5 is preferably situated above the wash water level in the drum-type washer dryer because the exhaust outlet 5 may be affected by the wash water.

The second outlet 10 opens at a front upper portion of the drum 1. The dry air, which is blown out from the second outlet 10, may reach distant positions from the second outlet 10 even if the exhaust outlet 5 is closer to the second outlet 10 since the dry air is blown out at high pressure and high air velocity from the second outlet 10. Therefore, the wrinkles are still effectively stretched because the contact between the laundry and the dry air is not weakened so much. The contact between the dry air and the laundry is not weakened so much. Therefore, the wrinkles are still effectively stretched by the dry air at high pressure and high velocity. The dry air at high pressure and high velocity is effectively blown to the laundry, which are bounced up by the rotation of the drum 1 to effectively decrease the wrinkles.

A damper 14 below the water tub 2 supports the water tub 2. The damper 14 damps resultant vibration of the water tub 2 from the rotation of the drum 1 under an unbalanced condition of weight because of uneven laundry distribution in the drum 1 during the spin-drying process and alike. The damper 14 is provided with a laundry amount detector 15 which detects vertical displacement of a damper shaft and alike, which results from a change in laundry weight in the supported water tub 2, to measure a laundry amount.

The drum-type washer dryer of this embodiment carries out a dehumidification and heating processes by means of the heat-pump technology. Therefore, the washer dryer has a heat pump device. The heat pump device has a compressor 16, which compresses refrigerant, a radiator 17, which emits heat of the refrigerant that becomes a high temperature and high pressure as a result of the compression, a neck portion 18, which decompresses the pressure of the pressurized refrigerant, a heat sink 19, which absorbs heat from the periphery by means of the refrigerant under resultant low pressure from the decompression, and a pipe line 20, which connects the aforementioned four elements to circulate the refrigerant. The heat sink 19 in the heat pump device is used as the aforementioned dehumidifier 6. The radiator 17 is used as the aforementioned heater 7.

It should be noted that the drum-type washer dryer is not limited to a heat pump-type system for drying laundry. For example, the dehumidifier 6 may be a water-cooling system which directly sprays water to the dry air. The heater 7 may be an electric heater. However, as described later, it is desirable if a heat pump system is used to dry the laundry.

As shown in FIG. 1, the drum-type washer dryer comprises an inflow temperature detector 71 such as a thermistor which detects a temperature of the dry air flowing into the drum 1. In this embodiment, the inflow temperature detector 71 is provided to or near the bifurcation of the first and second ducts 9, 11, which are situated at the downstream side of the blower 4. Consequently, the single inflow temperature detector 71 may detects the temperature of the dry air flowing into the drum under usage of the first or second duct 9, 11.

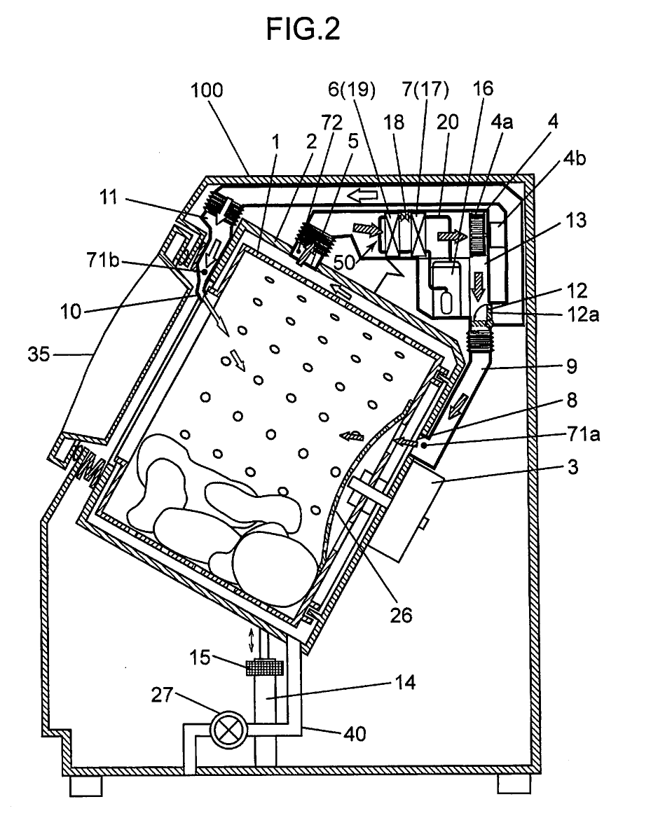

It should be noted that the inflow temperature detector 71a, which is situated at or beside the first outlet 8 of the first duct 9, and the inflow temperature detector 71b, which is situated at or beside the second outlet 10 of the second duct 11 may be used instead of the inflow temperature detector 71, as shown in FIG. 2. In this case, the temperature of the dry air immediately before the dry air flows into the drum 1 may be accurately detected although two inflow first temperature detectors 71a, 71b are required.

As shown in FIG. 1, the drum-type washer dryer comprises an exhaust temperature detector 72 such as a thermistor, which detects the temperature of the exhausted dry air from the drum 1 after the dry air comes into contact with the laundry. The exhaust temperature detector 72 is situated at or beside the exhaust outlet 5.

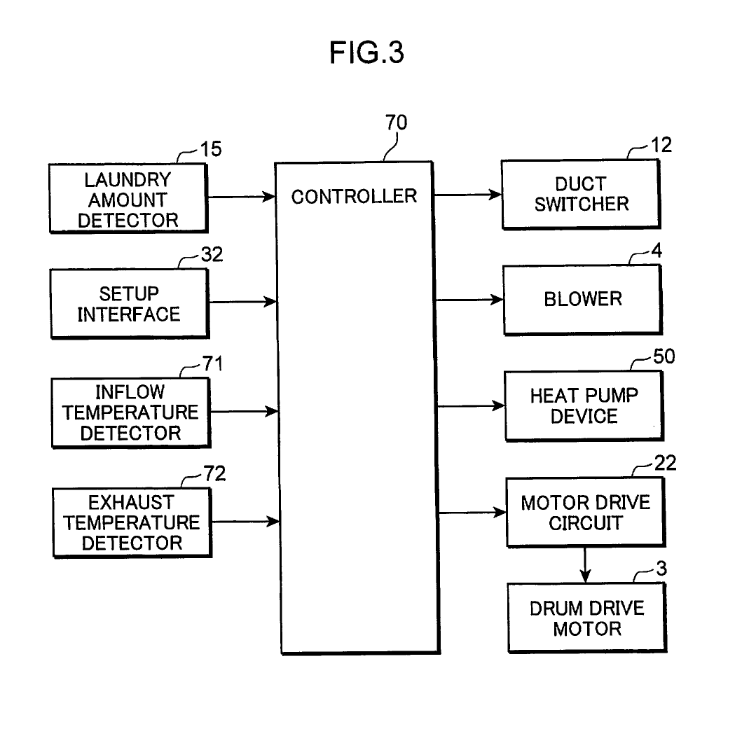

As shown in FIG. 3, the drum-type washer dryer includes a controller 70. The controller 70 controls a series of operations such as washing, rinsing, spin-drying and drying in response to setting information, which is input by the user via a setup interface 32, and monitored operational conditions of each component. For example, the controller 70 controls the rotation of the drum drive motor 3 via the motor drive circuit 22 and operations of the blower 4 and the heat pump device 50 in the drying process. The controller 70 also controls the duct switcher 12 to switch between the first and second ducts 9, 11 in response to the detection results of the inflow and exhaust temperature detectors 71, 72. For example, the controller 70 may comprise a CPU (Central Processing Unit: not shown), a ROM (Read Only Memory), which stores programs, a RAM (Random Access Memory), which stores programs and data during execution of various processes, an I/O interface, and a bus, which connects these components to each other.

It should be noted that several first outlets 8 may be provided although only one first outlet 8 of the first duct 9 is provided in this embodiment. Likewise, several second outlets 10 may be provided although only one second outlet 10 of the second duct 11 is exemplarily shown.

Operations, works and effects of the aforementioned drum-type washer dryer are described in detail.

It is described at first how the laundry wrinkles during the drying process. If laundry is dried in a confined drum, numerous wrinkles remaining on the laundry may dissatisfy the user. This is because the laundry is not stretched well in the confined drum during the drying process. In particular, the laundry is likely to wrinkle if the laundry contains a lot of cotton. Thus, end results of the drying process become worse.

If moisture is contained in the cotton fibers, the fibers may freely move. Accordingly, even if the laundry is bent by a resultant mechanical force to the laundry from the agitation caused by the rotation of the drum, the bent portion is stretched so that no wrinkles remain if a subsequent force works to stretch the laundry is applied. Therefore, it becomes less likely that the wrinkles occur in this period. If the moisture in the fibers decreases as progress of the drying process, a bonding force between the cotton fibers goes up and makes it difficult for the fibers to move. If a mechanical force bends the fibers, it becomes likely that the fibers keep bent. Subsequently, if the drying process further advances so that the moisture in the fibers further decreases, the fibers are likely to keep bent so that the fibers may not be easily stretched even under subsequent application of a force to stretch the laundry. Such a condition is referred to as “fixation of wrinkles”. It becomes likely that the wrinkles occur in this period because the bonding force between the cotton fibers increases. The resultant fixation of wrinkles from a decrease in moisture contradicts the requirement to evaporation of the moisture to dry the laundry which tends to cause the fixation. The greater the fixation of wrinkles, the worse the end results of the drying process.

The fibers are inevitably bent in a confined drum. Reduction in wrinkles and avoidance from sharply bending the fibers to cause strong wrinkle fixation are the key to moderating the wrinkles. Accordingly, it is preferable that the drying process advances with causing frequent changes in bending position to stretch and bend the fibers so that fibers are bent at one position and stretched at another position. If the drying advances under a stretched condition of the fibers which contain little moisture, a subsequent mechanical force is less likely to cause new wrinkles because the bonding between the fibers is too strong for the mechanical force to bend the fibers.

Accordingly, the drying process has ranges where the wrinkles become easily fixated and where the wrinkles is less likely to occur, which depend on a drying condition of the laundry. In terms of a dryness factor of laundry made from the cotton fibers, which are the most susceptible to wrinkles, if the dryness factor is ranged from substantially 85% (approximately 85%) to substantially 100% (approximately 100%), it is the most likely that the wrinkles are easily fixated on the laundry. In particular, if the dryness factor of the laundry made from the cotton fibers is ranged from substantially 90% (approximately 90%) to substantially 100% (approximately 100%), it is the most likely that the wrinkles are fixated on the laundry. The dryness factor (%) may be represented by the following formula.

Dryness factor (%)=(mass of standard laundry/mass of laundry containing moisture)×100

The term “mass of standard laundry” means the mass of laundry that is balanced under a condition at 20° C. of temperature and 65% of humidity.

Taking consideration of a dried condition of a single piece of a web, it is less likely that the web is evenly dried. Uneven dryness is partially observed on the web. For example, an area below the armpit of a long-sleeve shirt is not easily dried. Thus, it is usual that a target dryness factor at the completion of the drying process is not set to 100%. The drying process is designed so that the dryness factor exceeds 100% (e.g., dryness factor of 102% to 105%) at the end of the drying process to achieve an excessively dried condition. Accordingly, the drying process may be classified in response to the dryness factor into an early drying period until the dryness factor reaches substantially 90% just after the spin-drying process, during which it becomes less likely that wrinkles are fixated, a middle drying period from substantially 90% to substantially 100% of the dryness factor, during which it becomes likely that wrinkles are fixated, and a final drying period, during which the dryness factor exceeds 100% and the laundry hardly wrinkles.

In this embodiment, the wind is blown from the second outlet 10 of the second duct 11 at high pressure and high velocity to come into contact with the laundry during the middle drying period, so that the laundry is largely stretched to effectively reduce the wrinkles. A large air volume of wind is blown from the first outlet 8 of the first duct during at least one of the early and final drying periods. The switching operation between the first and second ducts 9, 11 in the drying process reduces wrinkles and saves power.

The timings of the early, middle and final drying periods in the drying process may be determined in response to the detection results of the exhaust temperature detector 72 (or the detection results of the inflow and exhaust temperature detectors 71, 72). This is explained below.

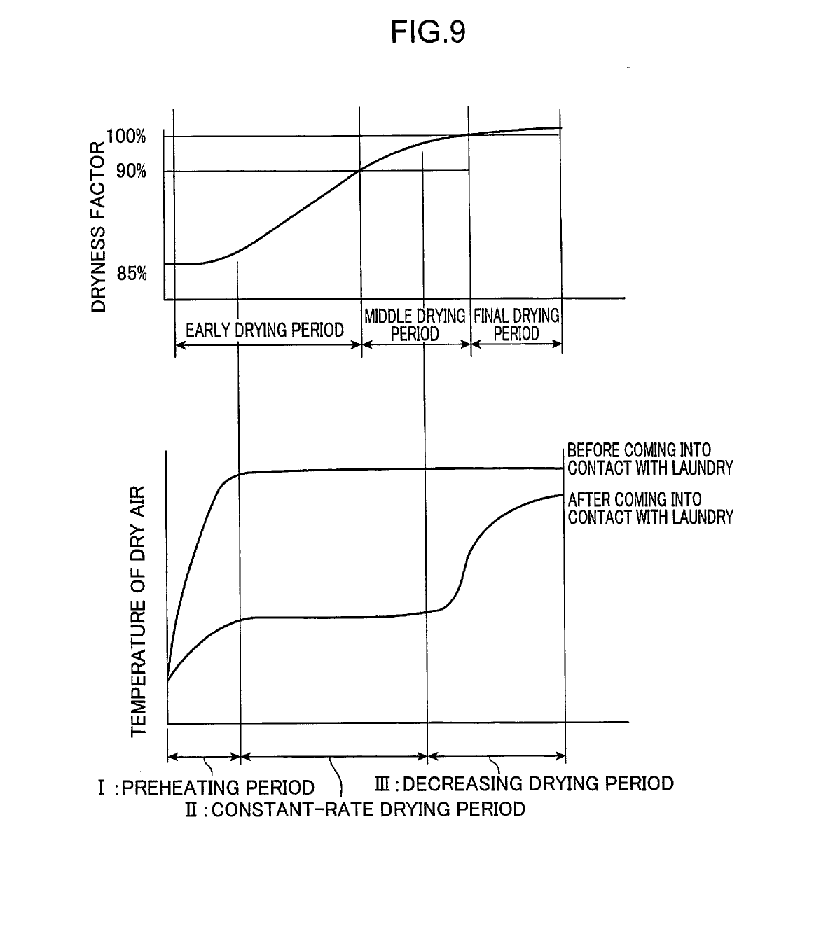

The preheating period, the constant-rate drying period and the decreasing drying period in the drying process are explained at first. In general, if sufficiently wet laundry is placed under a stable drying condition (e.g., if the laundry is placed in the dry air at a fixed temperature, humidity and air velocity), the dryness factor and dry air temperature during the drying process change as shown in FIG. 9. The drying process is classified into three drying periods.

### <I: Preheating Period>

The laundry is heated by the heat of the dry air.

### <II: Constant-Rate Drying Period>

There is moisture on the surface of the laundry, so that the moisture is consistently evaporated from the surface of the laundry. Thus, the mass of the wet laundry decreases at a constant rate.

### <III: Decreasing Drying Period>

The moisture is absent from the surface of the laundry, so that the moisture transfer from inner portions to the surface may not keep up with the evaporation from the surface of the laundry. Thus, the surface temperature of the laundry goes up whereas the drying speed gradually goes down.

The temperature of the dry air after the dry air comes into contact with the laundry gradually increases in “I: preheating period”, and then becomes a constant temperature in “II: constant-rate drying period”, and eventually increases once again in “III: decreasing drying period.”

The drying process also progresses during the constant-rate drying period, so that the dryness factor (mass ratio of the wet laundry, which is subjected to the drying process, to the mass of the laundry which serves as a reference of the dried laundry) increases. Accordingly, the change in the dryness factor in the constant-rate drying period may not be detected even if the temperature change of the dry air after the dry air comes into contact with the laundry is detected.

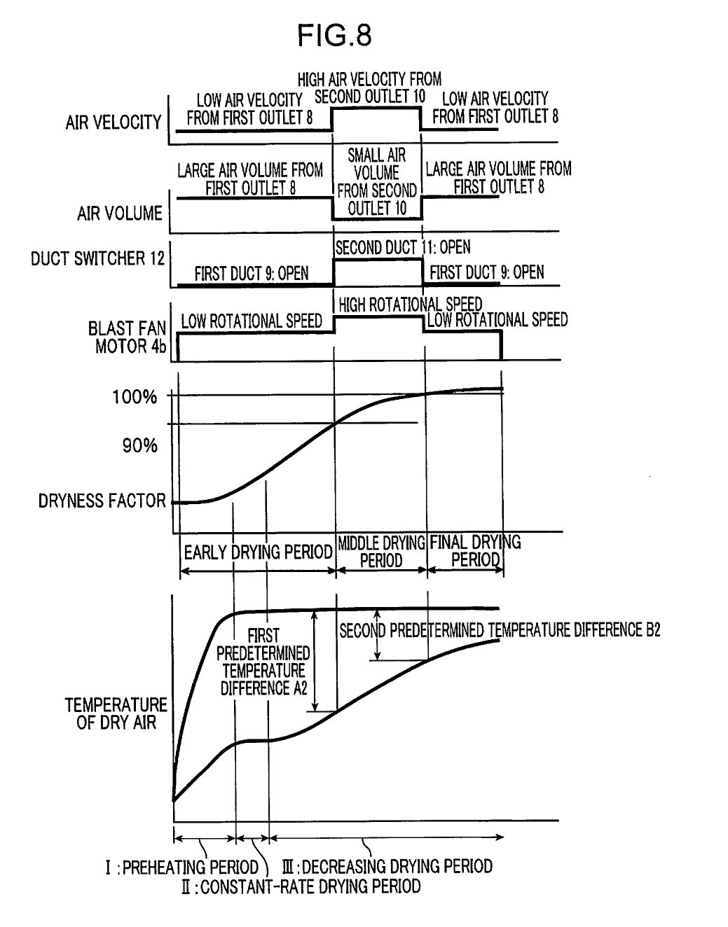

Newfangled washer dryers have better spin-drying performance so that the moisture contained in the laundry is considerably low to achieve a dryness factor level of 85% to 86% at the beginning of the drying process after completion of the washing and spin-drying processes. The dryness factor and dry air temperature change during the drying process as shown in FIG. 8 if the dry air, which is more capable of drying the laundry than before (a large volume of the dry air with low humidity) comes into contact with the laundry under these circumstances. In short, the moisture on the surface of the laundry evaporates to a certain degree during “I: preheating period”. After the surface of the laundry is dried to a certain degree, the moisture transfer from inner portions of the laundry may not keep up with the evaporation. In short, it takes a short time for the drying process to enter “III: decreasing drying period” from the start of the drying process mostly without the subsequent “II: constant-rate drying period”. The progress of the drying process; that is, the dryness factor of the laundry may be estimated on the basis of the change in the dry air temperature since the temperature of the dry air after the dry air comes into contact with the laundry gradually increases in this decreasing drying period.

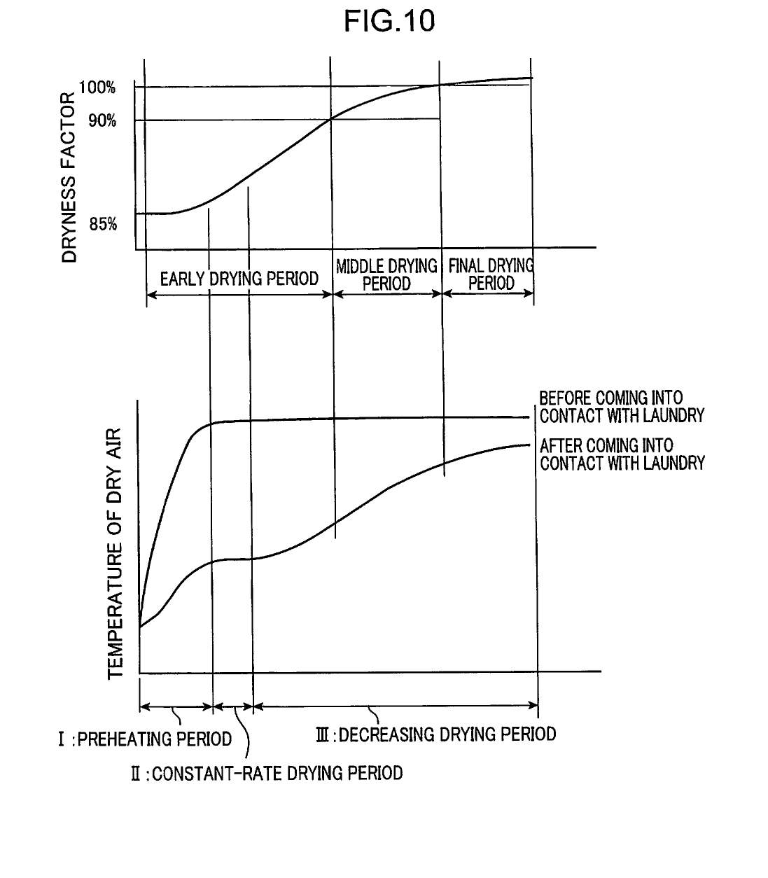

In the case of the drying process by means of a conventional heater system, the air is dehumidified only by water-cooling using tap water or air-cooling using air in the room. The air is then heated by an electric heater, and eventually used as the dry air. In the case of the drying process by means of such a conventional heater, it becomes less likely that the decreasing drying period occupies most of the drying process period as shown in FIG. 10. However, it becomes likely that the drying process excludes the constant-rate drying period and the decreasing drying period occupies the most of the drying process period as shown in FIG. 8, under usage of a large volume of the dry air generated by a heat pump system, which may dehumidify a large volume of air by means of refrigerant cool enough like the present embodiment. Thus, the heat pump system is a preferable configuration for the drying process.

The controller 70 may determine the timing of the early, middle and final drying periods in the drying process in response to the detection results of the exhaust temperature detector 72 (or the detection results of the inflow and exhaust temperature detectors 71, 72) in this embodiment, if the decreasing drying period occupies most of the drying process period as described above. The controller 70 controls the duct switcher 12 to switch between the first and second ducts 9, 11 on time. More specifically, the controller 70 determines a period from the start of the drying process to when the detected temperature by the exhaust temperature detector 72 becomes no less than a first predetermined temperature (or a difference between the detected temperatures by the inflow and exhaust temperature detector 71, 72 falls within a first predetermined temperature range) as the early drying period. The controller 70 determines a period, in which the detected temperature by the exhaust temperature detector 72 subsequently becomes no less than a second predetermined temperature (or a difference between the detected temperatures by the inflow and exhaust temperature detectors 71, 72 falls within a second predetermined temperature range), as the middle drying period. The controller 70 determines the subsequent period by the end of the drying process as the final drying period.

The timings of the early, middle and final drying periods may be determined in response to only the detected temperature of the exhaust temperature detector 72 because the temperature of the dry air, which is heated by the heater 7, (i.e., the temperature of the dry air, which flows into the drum 1) is substantially constant. It should be noted that the timings of the early, middle and final drying period may be more accurately determined in response to the differences between the detected temperatures by the inflow and exhaust temperature detectors 71, 72 so as to follow a slight temperature change in the dry air flowing into the drum 1.

As described above, the switching operation on time between the first and second ducts 9, 11 during the drying process causes few wrinkles and allows usage of the single blower 4. Since there is a time period, during which the laundry is dried by a large volumetric flow requiring less power than wind at high velocity, in the drying process, power consumption becomes relatively low in total, in comparison to conventional arts which use two blast fan motors to consistently blow out an increased volume of the dry air at high pressure and high velocity. Accordingly, the drum-type washer dryer of this embodiment may consume little power to achieve better end results of the drying process with few wrinkles on the laundry.

The exhaust outlet 5 is closer to the second outlet 10 at the front of the drum 1 and farther from the first outlet 8. Since the exhaust outlet 5 is situated at the front side of the drum 1, a distance between the first outlet 8 and the exhaust outlet 5 becomes long, so that the air blown from the first outlet 8 at the rear of the drum 1 is widely spread inside the drum 1. Thus, the dry air efficiently comes into contact with the laundry in the drum 1, so that the laundry may be dried with low power consumption.

The dry air may reach the rear from the front of the drum 1 even though the exhaust outlet 5 is closer to the second outlet 10 because the dry air is blown from the second outlet 10 at high pressure and high velocity. The contact between the dry air and the laundry may not be weakened so much under such a configuration. Therefore, the dry air at high pressure and high velocity still effectively stretches the wrinkles

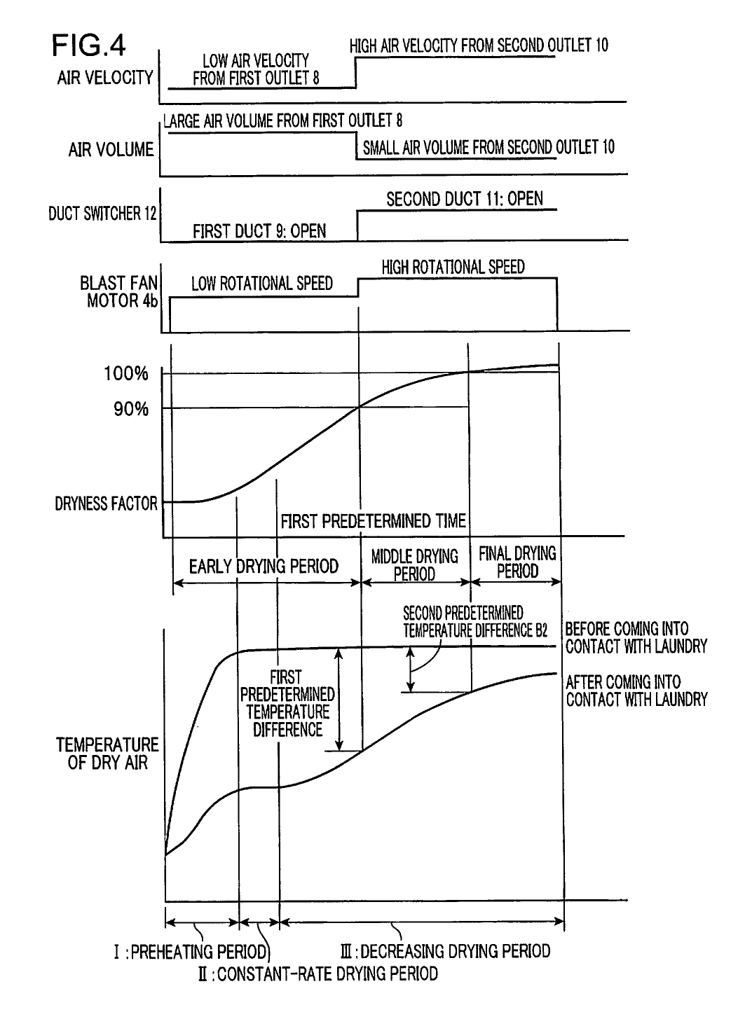

FIG. 4 is a time chart exemplifies the switching operation of the duct. The operation of the drum-type washer dryer, to which the first switching timing of the duct shown in FIG. 4 is applied, is described.

The first duct 9 is used during the early drying period from the start of the drying operation to when the difference in the dry air temperature before and after the dry air comes into contact with the laundry becomes the first predetermined temperature difference in the drying process because the first duct 9 has a large cross sectional area which allows the air passage with little pressure loss. Therefore, a large volume of the dry air is blown out from the first outlet 8 at the rear of the drum 1 to come into contact with the laundry. In short, the controller 70 controls the duct switcher 12 to open the first duct 9 and starts the drying operation. The controller 70 keeps the first duct 9 opened until the detected temperatures by the inflow and exhaust temperature detectors 71, 72 become different by the first predetermined temperature difference. In this case, a large volumetric air flow may be obtained by low rotational speed of the blast fan motor 4b, which allows the blower 4 to be driven with relatively low power consumption, because the pressure loss of the first duct 9 is small. The drying time, which is allocated to the early drying period, becomes short, which results in decreased power consumption during the early drying period.

In the middle and final drying periods from when the difference in the dry air temperature before and after the dry air comes into contact with the laundry becomes the first predetermined temperature difference, the duct switcher 12 switches to the second duct 11 and increases the rotational speed of the blast fan motor 4b. Consequently, in the middle and final drying periods, the dry air is blown at high pressure and high velocity from the second outlet 10, which has a narrower cross-sectional area than the first outlet 8 to allow the air passage, by the blast fan motor 4b, which rotates at high rotational speed. In short, the controller 70 controls the duct switcher 12 to open the second duct 11 if the detected temperatures by the inflow and exhaust temperature detectors 71, 72 become different by the first predetermined temperature difference. The controller 70 also controls the blower 4 to increase the rotational speed of the blast fan motor 4b. The controller 70 then keeps the second duct 11 opened until the end of the drying process. In this case, since the laundry is consistently stretched by the drying wind at high pressure and high velocity, the wrinkles are reduced.

Therefore, better end results of the drying process with few wrinkles on the laundry is obtained with smaller power consumption in total, in comparison to conventional arts which consistently use two blast fan motors to blow the dry air at high pressure and high velocity and increase the air volume.

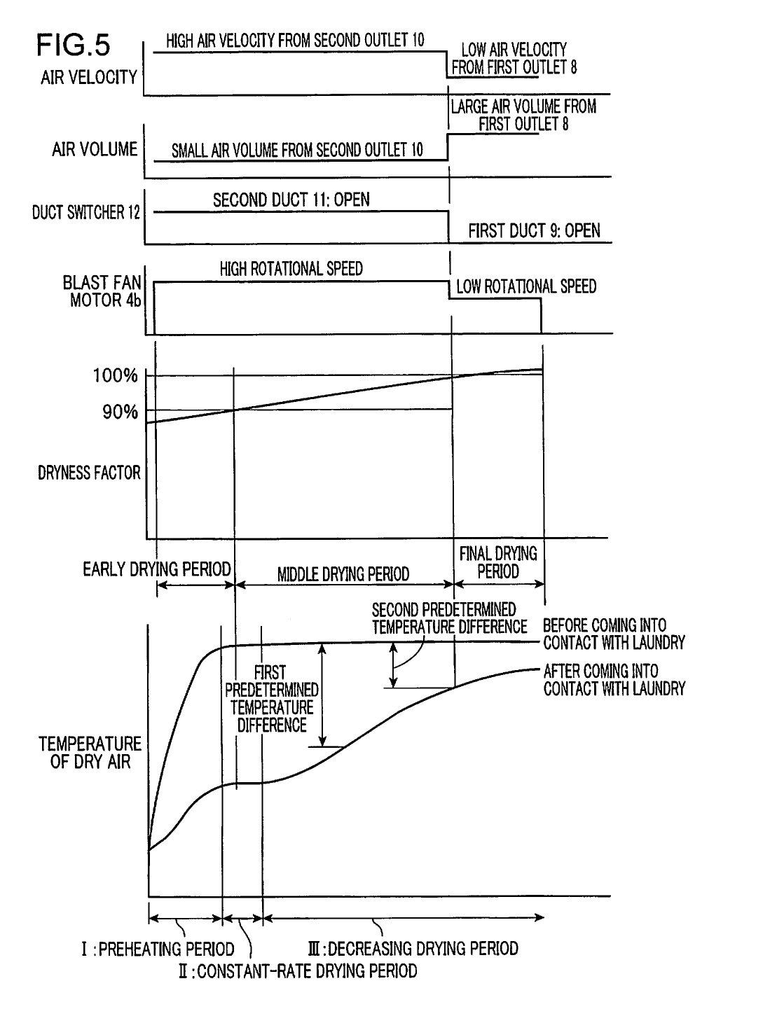

FIG. 5 is a time chart exemplifying another switching timing of the duct. The operation of the drum-type washer dryer, to which the second switching timing of the duct shown in FIG. 5 is applied, is described.

The second duct 11 is used during the early and middle drying period from the start of the drying operation to when the difference in the dry air temperature before and after the dry air comes into contact with the laundry becomes a second predetermined difference in the drying process. The dry air is blown at high pressure and high velocity from the second outlet 10, which has a narrow cross-sectional area to allow the air passage nearby the exhaust outlet, by the blast fan motor 4b rotating at high rotational speed. The dry air comes into contact with the laundry. In short, the controller 70 controls the duct switcher 12 to open the second duct 11 and starts the drying operation. The controller 70 then keeps the second duct 11 opened until the detected temperatures of the inflow and exhaust temperature detectors 71, detector 72 become different by a second predetermined temperature difference. In this case, since the laundry is consistently stretched by the dry wind at high pressure and high velocity, the wrinkles are reduced.

The duct switcher 12 then switches to the first duct 9 for the final drying period after the difference in the dry air temperature before and after the dry air comes into contact with the laundry becomes the second predetermined temperature difference. In the final drying period, the moisture contained in the laundry is small, so that it takes a long time for the dry air to hit and evaporate such a small amount of the moisture. Under such a condition, it is necessary to blow a large volume of the dry air into the drum 1, so that the dry air frequently comes into contact with the moisture. Accordingly, it is preferable to obtain a large volumetric air flow with low power consumption. Thus, the first duct 9, which has a large cross-sectional area that allows the air passage with little pressure loss, is used to blow out a large volume of the dry air from the first outlet 8 at the rear of the drum 1. The dry air comes into contact with the laundry. In short, the controller 70 controls the duct switcher 12 to open the first duct 9 if the detected temperatures of the inflow and exhaust temperature detectors 71, 72 become different by the second predetermined temperature difference. The controller also controls the blower 4 to decrease the rotational speed of the blast fan motor 4b. The controller 70 then keeps the first duct 9 opened until the end of the drying process. In this case, since the pressure loss of the first duct 9 is small, a large volumetric air flow may be obtained by a low rotational speed of the blast fan motor 4b, which results in relatively low power consumption at the driven blower 4. The drying time, which is allocated to the final drying period, becomes short, which results in decreased power consumption during the final drying period.

Therefore, better end results of the drying process with few wrinkles on the laundry is obtained with smaller power consumption in total, in comparison to conventional arts which consistently use two blast fan motors to blow the dry air at high pressure and high velocity and increase the air volume.

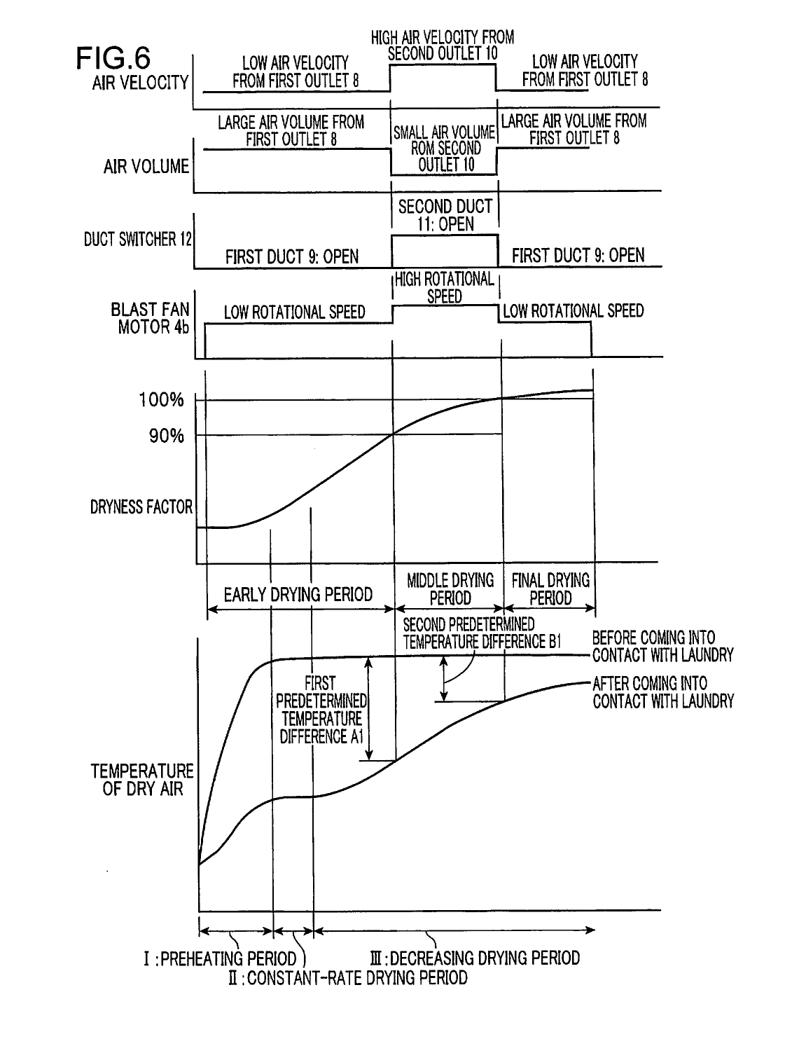

FIG. 6 is a time chart exemplifying another switching timing of the duct. The operation of the drum-type washer dryer, to which the third switching timing of the duct shown in FIG. 6 is applied, is described.

The first duct 9, which has a large cross-sectional area that allows the air passage with little pressure loss, is used during the early drying period from the start of the drying operation to when the difference in the dry air temperature before and after the dry air comes into contact with the laundry becomes the first predetermined temperature difference in the drying process. A large volume of the dry air is blown out from the first outlet 8 at the rear of the drum 1 and comes into contact with the laundry. In short, the controller 70 controls the duct switcher 12 to open the first duct 9 and starts the drying operation. The controller 70 then keeps the first duct 9 opened until the detected temperatures by the inflow and exhaust temperature detectors 71, 72 become different by the first predetermined temperature difference. In this case, since the pressure loss of the first duct 9 is small, a large volumetric air flow is obtained by relatively low rotational speed of the blast fan motor 4b, so that the blower 4 is driven with relatively low power consumption. Thus, the drying time, which is allocated to the early drying period, becomes short, which results in decreased power consumption during the early drying period.

In the middle drying period after the difference in the dry air temperature before and after the dry air comes into contact with the laundry becomes the first predetermined temperature difference, the duct switcher 12 switches to the second duct 11 while the blast fan motor 4b increases the rotational speed. Consequently, in the middle drying period, the dry air is blown at high pressure and high velocity by the blast fan motor 4b rotating at high rotational speed from the second outlet 10, which has a narrower cross-sectional area than the first outlet 8 to allow the air passage. In short, the controller 70 controls the duct switcher 12 to open the second duct 9 if the detected temperatures by the inflow and exhaust temperature detectors 71, 72 become different by the first predetermined temperature difference. The controller 70 also controls the blower 4 to increase the rotational speed of the blast fan motor 4b. The controller 70 then keeps the second duct 11 opened until the detected temperatures by the inflow and exhaust temperature detector 71, 72 become different by the second predetermined temperature difference. In this case, since the laundry is consistently stretched by the dry wind at high pressure and high velocity, the wrinkles are reduced.

The duct switcher 12 then switches to the first duct 9 for the final drying period after the difference in the dry air temperature before and after the dry air comes into contact with the laundry becomes the second predetermined temperature difference. In the final drying period, the moisture contained in the laundry is small. Therefore, it takes a long time for the dry air to hit and evaporate such a small amount of the moisture. Under such a condition, it is necessary to blow a large volume of the dry air into the drum 1 and make the dry air frequently come into contact with the moisture. Accordingly, it is preferable to obtain a large volumetric air flow with low power consumption. Thus, the first duct 9, which has a large cross-sectional area to allow the air passage with little pressure loss, is used to blow out a large volume of the dry air from the first outlet 8 at the rear of the drum 1 and make the dry air come into contact with the laundry. In short, the controller 70 controls the duct switcher 12 to open the first duct 9 if the detected temperatures by the inflow and exhaust temperature detectors 71, 72 become different by the second predetermined temperature difference. The controller 70 also controls the blower 4 to decrease the rotational speed of the blast fan motor 4b. The controller 70 then keeps the first duct 9 opened until the end of the drying process. In this case, since the pressure loss of the first duct 9 is small, a large volumetric air flow is obtained even if the rotational speed of the blast fan motor 4b is set relatively low. Therefore, the blower 4 may be driven with relatively low power consumption. Thus, the drying time, which is allocated to the final drying period, becomes short, which results in decreased the power consumption during the final drying period.

Therefore, better end results of the drying process with few wrinkles on the laundry is obtained with smaller power consumption in total, in comparison to conventional arts which consistently use two blast fan motors to blow the dry air at high pressure and high velocity and increase the air volume.

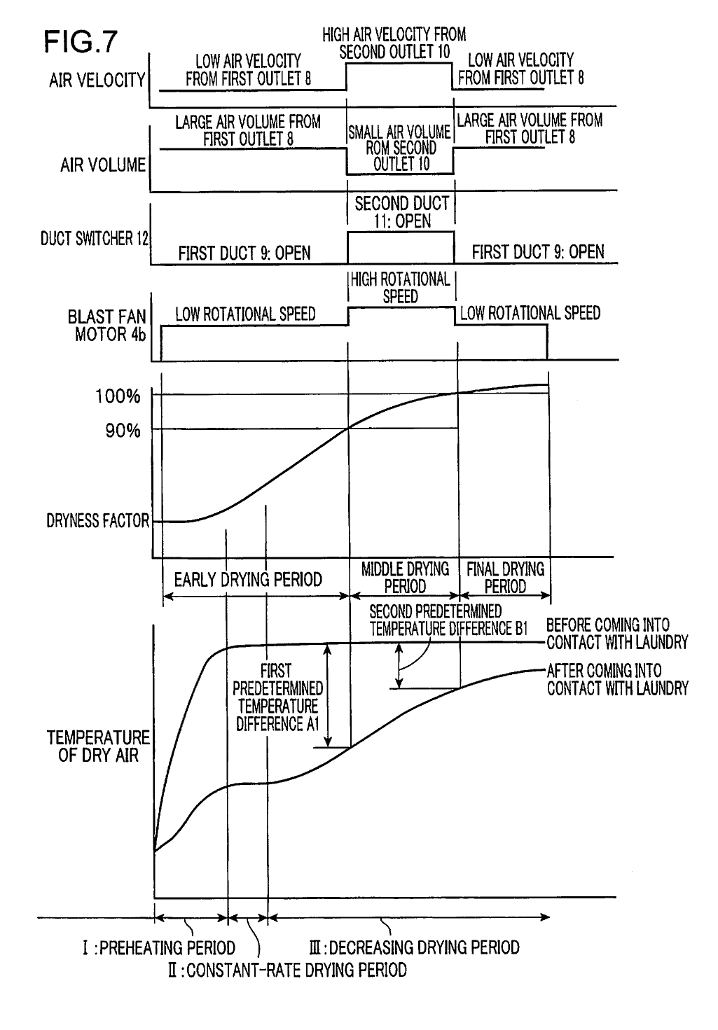

FIGS. 7 and 8 are time charts exemplifying another switching timing of the duct. The operation of the drum-type washer dryer, to which the fourth switching timing of the duct shown in FIGS. 7 and 8 is applied, is described.

As described above, the controller 70 determines the timings of each of the early, middle and final drying periods in the drying process in response to the difference (the first and second predetermined temperature differences) of the detected temperatures by the inflow and exhaust temperature detectors 71, 72. The first and second predetermined temperature differences, however, depend on a laundry amount to be dried because the dry air comes into contact with a wider surface area of the laundry if the laundry amount to be dried becomes large. This also means an increased evaporation amount of the moisture from the laundry surface. The increase in the evaporation amount of the moisture means increased consumption of the dry air heat. Therefore, the dry air temperature decreases after the dry air comes into contact with the laundry as the laundry amount to be dried increases. In short, the first and second predetermined temperature differences as the difference in the dry air temperature before and after the dry air comes into contact with the laundry increases as the laundry amount to be dried increases. Thus, in this embodiment, the laundry amount detector 15 is used to detect the laundry amount to be dried. The first and second predetermined temperature differences as the criteria for determining each period are changed in response to the detection results.

The laundry amount detector 15 detects an amount (mass) of the laundry placed in the drum 1 before the start of the washing process. Specifically, the laundry amount detector 15 detects the amount of the laundry placed in the drum 1 on the basis of a difference between a shaft position of the damper 14 when the water tub 2 is empty (i.e., there is no water in the water tub 2 and no laundry is placed in the drum 1) and a shaft position of the damper 14 before the start of the washing process to supply water into the water tub 2 (i.e. there is no water in the water tub 2 while the laundry is placed in the drum 1).

The controller 70 then sets the first and second predetermined temperature differences in response to the detection results by the laundry amount detector 15. FIG. 7 shows operations under a condition where the amount of the laundry to be dried is less than FIG. 8. If the laundry amount is small, the controller 70 sets the first predetermined temperature difference to Al and the second predetermined temperature difference to A2 as shown in FIG. 7. On the other hand, if the laundry amount is great, the controller 70 sets the first predetermined temperature difference to B1 and the second predetermined temperature difference to B2 as shown in FIG. 8. In the case of FIG. 8, the first and second predetermined temperature differences when the dryness factor reaches 90% or 100% become greater than the case of FIG. 7. Thus, the controller 70 sets the first and second predetermined temperature differences to achieve A1<B1, A2<B2. In short, the controller 70 increases the first and second predetermined temperature differences as the laundry amount to be dried increases.

As a result of optimizing the first and second predetermined temperature differences, which are used as the criteria for determining the timings of the early, middle and final drying periods in response to the laundry amount to be dried as described above, the first and second ducts 9, 11 may be effectively switched in the drying process to obtain better end results of the drying process with few wrinkles on laundry and with smaller total power consumption, in comparison to conventional arts which consistently use two blast fan motors to blow out the dry air at high pressure and high velocity and increase the air volume.

It should be noted that the adjustment to the first and second predetermined temperature differences in response to the detection results of the laundry amount may be applied to any one of the first to third switching timings of the duct shown in FIGS. 4 to 6.

The vertical displacement of the shaft of the damper 14 is exemplarily detected by the laundry amount detector 15 but the present embodiment is not limited thereto. For example, the laundry amount detector may detect changes in parameters such as load, rotational speed, drive current, torque or alike of the drum drive motor 3 to identify the laundry amount in the drum 1 from the variance of the load of the drum drive motor 3.

The exemplary controller 70 automatically adjusts the first and second predetermined temperature differences in response to the detection results of the laundry amount detector 15 in this embodiment. Even without the laundry amount detector 15, the user may input the laundry amount to the setup interface 32, so that the controller 70 changes the first and second predetermined temperature differences in response to the user input.

The drum-type washer dryer, which has the washing function as well as the laundry drying function, is explained but the present invention is not limited thereto. The present invention may be applied to a laundry dryer without the washing function. It may be exemplified as the laundry dryer if the washing function is excluded from the drum-type washer dryer shown in FIG. 1. For example, the laundry dryer without the washing function does not require any connection of the water supply pipe or drain pipe 40 to the water tub 2 of FIG. 1. Thus, the water tube 2 may work as an outer shell of the drum 1 while other configurations of the drum-type washer dryer of FIG. 1 are kept the same.

The present invention is applied to the drum-type washer dryer in the described embodiment but the present invention is not limited to the drum-type washer dryer. In short, since the laundry dryer and the washer dryer of the present invention aim to reduce the total power consumption of the blast fan motor, shorten the drying period, and make the laundry dried with few wrinkles and with low power consumption, the present invention may be applied to hang-type drying or pulsator-type vertical washer dryers other than drum-type washer dryers.

The laundry dryer according to one aspect of the present invention has: a storage portion which stores laundry to be dried; a first duct including a first outlet which opens toward the storage portion; a second duct including a second outlet which has a narrower cross-section allowing air to pass than the first outlet; a duct switcher which selectively switches between the first and second ducts; a blower which blows dry air so that a larger volume of the dry air is blown from the first outlet into the storage portion under selection of the first duct than the second duct and so that the dry air is blown from the second outlet into the storage portion at higher pressure and higher velocity under selection of the second duct than the first duct; an exhaust temperature detector which detects a temperature of the dry air exhausted from the storage portion after the dry air comes into contact with the laundry; and a controller which controls the duct switcher in response to a detection result of the exhaust temperature detector to selectively switch between the first and second ducts during a drying process.

According to the aforementioned configuration, two ducts; namely, the first and second ducts are used to direct the dry air to the storage portion which stores the laundry. These two ducts may be switched by the duct switcher. The first outlet of the first duct has a wider cross-sectional area through which air passes and less pressure loss than the second outlet of the second duct. A larger volume of the dry air is blown from the first outlet into the storage portion, under selection of the first outlet which opens toward the storage portion, than under selection of the second outlet. In this case, the blower may be driven with relatively low power consumption to obtain the large air volume due to the low pressure loss of the first duct. Thus, the time of drying operation with the large air volume is shortened, which results in decreased power consumption. On the other hand, the second outlet of the second duct has a narrower cross-section, through which the air passes, than the first outlet. The dry air is blown from the second outlet into the storage portion at higher pressure and higher velocity under selection of the second duct than the first duct. In this case, the laundry is stretched by the air at high-pressure and high-velocity to reduce wrinkles.

It should be noted that, if the surface of the laundry is uncovered with a water coating in the drying process because of a decrease in moisture on the surface of the laundry, the moisture transfer from inner portions to the surface of the laundry may not keep up with the evaporation from the surface of the laundry, which results in a decreasing drying period where the drying speed gradually decreases. The dry air temperature after the dry air comes into contact with the laundry gradually increases in this decreasing drying period. Accordingly, the progress of the drying process; that is, the dryness factor of the laundry may be estimated on the basis of the change in the dry air temperature. Thus, the aforementioned first and second ducts are selectively switched during the drying process in response to the temperature of the dry air, which is exhausted from the storage portion after the dry air comes into contact with the laundry. For example, the first duct may be selected for a dryness factor period, in which the laundry is less likely to wrinkle. The second duct may be selected for another dryness factor period in which the laundry is likely to wrinkle. Accordingly, the laundry may be dried with one blower. During the drying process, the laundry is dried with the large volume air, which consumes less power than the air at high velocity. Therefore, the drying process causes few wrinkles and consumes little power.

In the aforementioned configuration, preferably, the first outlet opens at a rear side of the storage portion, and the second outlet opens at a front side of the storage portion.

According to the aforementioned configuration, if a mixture of small and long laundries is dried and if a large volume of the dry air is blown from the first outlet at the rear end of the drum, the dry air comes into contact with the small laundry at first, which tends to gather at the back of the drum. The dry air then passes through the small laundry to reach the long laundry at the front of the drum. Thus, both the small and long laundries may be efficiently dried. In particular, the small laundry may be dried with relatively few wrinkles. On the other hand, the long laundry tends to wrinkle because sleeves or alike are easily twisted by the agitation during the drying process. The long laundry tends to gather at the front of the drum. Therefore, the drying speed may go up if wind (dry air) comes in contact with the long laundry from the second outlet at the front of the drum. If the wind (dry air) is blown from the second outlet at high pressure and high velocity to come into contact with the long laundry, it becomes likely that the long laundry is more stretched. Since the long laundry is moved a lot by the wind, the wrinkles are effectively decreased.

In the aforementioned configuration, preferably, the laundry dryer further comprises an inflow temperature detector which detects the temperature of the dry air flowing into the storage portion, wherein the controller selects the first duct for an early drying period from a start of the drying process to when a difference between temperatures detected by the inflow and exhaust temperature detectors falls within a first predetermined temperature range, and selects the second duct from a middle drying period after the difference falls within the first predetermined temperature range.

In the aforementioned configuration, since the first and second ducts are switched in response to the difference between the detected temperatures by the inflow and exhaust temperature detectors (i.e., the difference of the dry air temperature before and after the dry air comes into contact with the laundry in the storage portion), the switching operation becomes accurate so that the switching operation follows a slight change in the dry air temperature, which flows into the storage portion. The first duct, which has a large cross-sectional area that allows air passage with small pressure loss, is used during the early drying period until when the temperature difference falls within the first predetermined temperature range. Therefore, a large volume of the dry air comes into contact with the laundry. In this case, since the pressure loss of the first duct is small, a large volumetric air flow is obtained by the blower driven with relatively low power consumption. Thus, the drying time with the large volumetric air flow becomes short, which results in decreased power consumption. In addition, the air flow path is switched to the second duct after the subsequent middle drying period. It is likely that the wrinkles occur and become fixated during the middle drying period. The laundry is, however, effectively stretched by the dry air at high pressure and high velocity, which is blown out from the second outlet to decrease the wrinkles. Therefore, there may be less power consumption and few wrinkles on the finished laundry after the drying process in comparison to conventional arts in which two blowers are consistently used to blow an increased volume of the dry air at high pressure and high velocity.

In the aforementioned configuration, preferably, the controller selects the first duct once again for a final drying period after the difference between the temperatures detected by the inflow and exhaust temperature detectors falls within a second predetermined temperature range, which is narrower than the first predetermined temperature range.

According to the aforementioned configuration, the air flow path is switched once again to the first duct during the final drying period after the temperature difference between the detected temperatures by the inflow and exhaust temperature detectors falls within the second predetermined temperature range. In the final drying period, the moisture contained in the laundry is small. Therefore, it takes a long time for the dry air to hit and evaporate such a small amount of the moisture. Under such a condition, it is necessary to blow a large air volume of the dry air into the storage portion and lengthen a contact time between the dry air and the laundry. Thus, the first duct, which has a large cross-sectional area allowing the air passage with small pressure loss, is used so that a large volume of the dry air slowly comes into contact with the laundry. In this case, a large volumetric wind may be obtained by the blower driven with low power consumption since the pressure loss of the first duct is small. Thus, the drying time in the final drying period becomes short, which results in decreased power consumption during the final drying period. Accordingly, the total power consumption is also decreased.

In the aforementioned configuration, preferably, the controller selects the second duct for an early drying period and a middle drying period before a difference between temperatures detected by the inflow and exhaust temperature detectors falls within a second predetermined temperature range, and selects the first duct for a final drying period after the difference falls within the second predetermined temperature range.

According to the aforementioned configuration, the second duct is used during the early and middle drying periods until when the temperature difference between the detected temperatures by the inflow and exhaust temperature detectors falls within the second predetermined temperature range. The moisture contained in the laundry after the spin-drying considerably depends on types of fibers, texture and alike of the laundry. In the case of laundry containing numerous chemical fibers, the moisture content after the spin-drying; that is, the initial dryness factor is considerably high at nearly 90%. In the case of these kinds of laundry, it is likely that the wrinkles occur and become fixated during the early and middle drying periods. The laundry is, however, consistently stretched by the dry air at high pressure and high velocity, which is blown out from the second outlet of the second duct, to decrease the wrinkles. Since the laundry is effectively stretched by the dry air at high pressure and high velocity, which is blown out from the second outlet of the second duct, the wrinkles are reduced. Subsequently, the first duct is used in the aforementioned final drying period. As described above, in the final drying period, the moisture contained in the laundry is small, and it takes a long time for the dry air to hit and evaporate such a small amount of the moisture. Thus, a large volume of the dry air is blown out from the first outlet of the first duct into the storage portion and makes it frequent for the dry air to come into contact with the laundry during the final drying period. In this case, a large volumetric wind may be obtained by the blower driven with low power consumption since the pressure loss of the first duct is smaller than the second duct. Thus, the drying time in the final drying period is shortened, which results in decreased power consumption during the final drying period. Therefore, there may be less power consumption and few wrinkles on the finished laundry after the drying process in comparison to conventional arts in which two blowers are consistently used to blow an increased volume of the dry air at high pressure and high velocity.

In the aforementioned configuration, preferably, the laundry dryer further comprises a laundry amount detector which detects a laundry amount in the storage portion, wherein the controller sets the first or second predetermined temperature range in response to the laundry amount detected by the laundry amount detector.

In the aforementioned configuration, if a large amount of the laundry is dried, the dry air comes into contact with a large surface area of the laundry. This means that an evaporated amount of the moisture from the laundry surface also goes up. The increase in the evaporated amount of the moisture means that heat of the dry air is increasingly consumed, which results in large temperature drop of the dry air after the dry air comes into contact with the laundry as the laundry amount to be dried. In short, the first and second predetermined temperature difference ranges as the temperature difference of the dry air before and after the dry air comes into contact with the laundry are preferably set greater as the laundry amount to be dried increases. Thus, the laundry amount detector is provided to detect the laundry amount in the storage portion. The first or second predetermined temperature difference range as the criteria for determining each period are set in response to the laundry amount. Accordingly, as a result of optimizing each period of the early, middle and final drying periods in response to the laundry amount to be dried, the first and second ducts may be effectively switched in the drying process, which leads to preferable end results of the drying process with few wrinkles on laundry and effectively decreased power consumption.

In the aforementioned configuration, preferably, the storage portion is a cylindrical drum, the laundry dryer further comprising: a drum driver which drives and rotates the drum; a dehumidifier which dehumidifies the dry air under humidity after exhaust from the drum; a heater which heats the dry air after dehumidification by the dehumidifier; and a circulation duct in which the blower and the duct switcher are situated so that the dry air is sequentially circulated from the drum to the first or second outlet through the exhaust outlet, the dehumidifier and the heater.

Like the aforementioned configuration, the so-called drum-type laundry dryer may utilize the drum as the storage portion. Since a drum-type laundry dryer dries the laundry in a limited and confined drum space, it is difficult to obtain preferable end results of the drying process with few wrinkles under power saving. However, according to the present invention, the drum-type laundry dryer may dry the laundry with few wrinkles under decreased power consumption.

In the aforementioned configuration, preferably, a heat pump device works as the dehumidifier and the heater. If the heat pump device is used to dehumidify and heat the dry air as described above, a large volume of the dry air is generated with very effective dehumidification in comparison to a heating system which uses an electric heater to heat the air that is dehumidified only by water-cooling using tap water or air-cooling using air. Therefore, it is likely that the drying process excludes a constant-rate drying period and most of the drying process is the decreasing drying period. If most of the drying process is the decreasing drying period, the progress of the drying process (the dryness factor of the laundry) is easily estimated in response to the dry air temperature after the dry air comes into contact with the laundry. Since the temperature rise of the laundry becomes dramatically small in comparison to the heater system, it becomes less likely that the laundry is subjected to thermal degradation. Thus, the laundry keeps durable and its preferable texture over a long period of time.

In the aforementioned configuration, preferably, the controller controls the duct switcher in response to a detection result of the exhaust temperature detector during a decreasing drying period where a speed of drying laundry in the storage portion gradually decreases.

In the aforementioned configuration, the progress of the drying process (the dryness factor of the laundry) may be estimated in response to the dry air temperature after the dry air comes into contact with the laundry during the decreasing drying period in the drying process. Therefore, the controller may control the duct switcher to effectively switch between the first and second ducts.

The washer dryer according to the present invention includes any one of the aforementioned laundry dryers, and a water tub in which the storage portion is stored. The water tub stores wash water. Any one of the aforementioned laundry dryers may be utilized to fabricate a washer dryer configured to dry the laundry with few wrinkling under low power consumption.

The specific embodiments and examples described in the section of Description of the Invention are provided merely for clarifying technical contents of the present invention. Therefore, this invention should not be narrowly interpreted as being limited to such specific examples. This invention may be implemented by being variously modified within a scope of the spirit of the present invention and the ensuing claims.

### INDUSTRIAL APPLICABILITY

The laundry dryer and washer dryer of the present invention may be suitably applied to various types of laundry dryer and washer dryers such as drum-type, hang dry-type or pulsator-type dryers.

1. A laundry dryer, comprising:
a storage portion which stores laundry to be dried;
a first duct including a first outlet which opens toward the storage portion;
a second duct including a second outlet which has a narrower cross-section allowing air to pass than the first outlet;
a duct switcher which selectively switches between the first and second ducts;
a blower which blows dry air so that a larger volume of the dry air is blown from the first outlet into the storage portion under selection of the first duct than the second duct and so that the dry air is blown from the second outlet into the storage portion at higher pressure and higher velocity under selection of the second duct than the first duct;
an exhaust temperature detector which detects a temperature of the dry air exhausted from the storage portion after the dry air comes into contact with the laundry; and
a controller which controls the duct switcher in response to a detection result of the exhaust temperature detector to selectively switch between the first and second ducts during a drying process.

2. The laundry dryer according to claim 1, wherein
the first outlet opens at a rear side of the storage portion, and
the second outlet opens at a front side of the storage portion.

3. The laundry dryer according to claim 1, further comprising an inflow temperature detector which detects the temperature of the dry air flowing into the storage portion, wherein
the controller selects the first duct for an early drying period from a start of the drying process to when a difference between temperatures detected by the inflow and exhaust temperature detectors falls within a first predetermined temperature range, and selects the second duct from a middle drying period after the difference falls within the first predetermined temperature range.

4. The laundry dryer according to claim 3, wherein
the controller selects the first duct once again for a final drying period after the difference between the temperatures detected by the inflow and exhaust temperature detectors falls within a second predetermined temperature range, which is narrower than the first predetermined temperature range.

5. The laundry dryer according to claim 1, wherein
the controller selects the second duct for an early drying period and a middle drying period before a difference between temperatures detected by the inflow and exhaust temperature detectors falls within a second predetermined temperature range, and selects the first duct for a final drying period after the difference falls within the second predetermined temperature range.

6. The laundry dryer according to claim 3, further comprising a laundry amount detector which detects a laundry amount in the storage portion, wherein
the controller sets the first or second predetermined temperature range in response to the laundry amount detected by the laundry amount detector.

7. The laundry dryer according to claim 1, wherein
the storage portion is a cylindrical drum,
the laundry dryer further comprising:
a drum driver which drives and rotates the drum;
a dehumidifier which dehumidifies the dry air under humidity after exhaust from the drum;
a heater which heats the dry air after dehumidification by the dehumidifier; and
a circulation duct in which the blower and the duct switcher are situated so that the dry air is sequentially circulated from the drum to the first or second outlet through the exhaust outlet, the dehumidifier and the heater.

8. The laundry dryer according to claim 7, wherein
a heat pump device works as the dehumidifier and the heater.

9. The laundry dryer according to claim 1, wherein
the controller controls the duct switcher in response to a detection result of the exhaust temperature detector during a decreasing drying period where a speed of drying laundry in the storage portion gradually decreases.

10. A washer dryer, comprising:
the laundry dryer according to claim 1; and
a water tub in which the storage portion is stored, the water tub storing wash water.
